(19) United States
(12) Patent Application Publication
(10) Pub. No.: US 2015/0242284 A1
(43) Pub. Date: Aug. 27, 2015

(54) TWO-ALGORITHM SORT DURING BACKUP AND RECOVERY

(71) Applicant: CA, Inc., Islandia, NY (US)

(72) Inventor: Paul P. Ignatius, North Grafton, MA (US)

(73) Assignee: CA, Inc., Islandia, NY (US)

(21) Appl. No.: 14/189,153

(22) Filed: Feb. 25, 2014

(51) Int. Cl. G06F 11/14; G06F 17/30

(52) U.S. Cl. CPC G06F 11/1448; G06F 17/3053; G06F 17/30867

(57) ABSTRACT

A backup of a file system is performed by scanning a file system to find elements that require a backup. Once at least one element is found, element identifiers associated with the elements are sorted using a first sorting algorithm to select an element for backup, and the element identifier associated with the selected element is appended to a backup list. A second sorting algorithm may also sort in parallel to the first sorting algorithm. The sorted elements are appended to the backup list until a predetermined rule is satisfied, when the remainder of the elements are sorted using a second sorting algorithm different from the first sorting algorithm. The element identifiers associated with the remaining elements are appended to the backup list in an order determined by the second sorting algorithm. While the sorting is occurring, the elements are backed up in the order of the backup list.

### BACKGROUND

Various aspects of the present disclosure relate generally to backing up computer systems and recovering backed up elements to a computer system.

In a typical computer system, data can be lost due to file deletion, file corruption or a computer system crash. Moreover, situations may arise where a user wants to revert back to an earlier version of a file. In order to minimize loss of data due to the above types of occurrences, a user can create a backup of the computer system onto a backup system, which stores the backup in one more catalogs. A backup system may store the backup catalogs on a file server, a tape drive, external drive, a network attachable storage (NAS), the cloud, etc. Once a full backup is completed, subsequent backups can be performed as partial backups (e.g., incremental, differential, reverse delta, etc.). When performing a backup, elements (e.g., files and directories) are sorted to ensure that no element that needs to be backed up is missed or repeated.

If a user wants to recover the elements stored on a backup system, the backed up elements are located within the backup catalogs and the catalog entry information about the elements and their location on storage media are merged to create a list of elements to recover. The catalogs must then be sorted to eliminate restoring the same element multiple times. Further, the list of files or element may be sorted to find the oldest version of a file, etc.

Two example sorting algorithms are a bubble sort and a quicksort. A bubble sort requires time on the order of N² (where N is the number of elements to be sorted). On the other hand, a quicksort requires time on the order of N*log(N).

### BRIEF SUMMARY

According to aspects of the present disclosure, a method of creating a backup of a file system is disclosed. The method comprises identifying elements for backup, wherein the elements include element identifiers. For instance, elements may be identified by scanning a file system to find elements that require a backup, where the elements include element identifiers (e.g., file name, file size, timestamp, other metadata, the file itself, a checksum, etc., or combinations thereof).

The method further comprises sorting, using a first sorting algorithm, element identifiers of elements identified for backup to select a sorted element and append the element identifier associated with the selected element to a backup list. For instance, sorting using the first algorithm may be performed using a process that repeats until a predetermined rule is satisfied. The process includes sorting, using a first sorting algorithm, the element identifiers to select an element for backup and appending the element identifier associated with the selected element to a backup list. When the predetermined rule is satisfied, sorting using the first sorting algorithm is stopped.

The method still further comprises using a second sorting algorithm different from the first sorting algorithm to sort element identifiers that are not already selected by the first sorting algorithm. In this regard, the sort using the second sorting algorithm may start or otherwise occur in parallel with the sort using the first algorithm, e.g., by starting before the predetermined rule is satisfied. Alternatively, the second sorting algorithm can start after the first sorting algorithm has stopped, e.g., the second sorting algorithm can start after the predetermined rule is satisfied.

Also, the method includes appending the element identifiers sorted by the second sorting algorithm to the backup list in an order determined by the second sorting algorithm. Still further, the method includes backing up the elements associated with the element identifiers in the backup list in the order in which the element identifiers are in the backup list. Here, backing up occurs in parallel with a select one of: the sorting using the second algorithm, and both the sorting using the second sorting algorithm and the sorting using the first sorting algorithm.

According to further aspects of the present disclosure, a method of recovering a backup to a file system is disclosed. The method comprises identifying elements for recovery, where the elements include element identifiers. For instance, elements may be identified by merging backup catalogs to find elements that are required for a recovery, where the elements include element identifiers.

The method further comprises sorting, using a first sorting algorithm, element identifiers of elements identified for recovery to select a sorted element and append the element identifier associated with the selected element to a recovery list. For instance, sorting using the first algorithm may be performed using a process that repeats until a predetermined rule is satisfied. The process includes sorting, using a first sorting algorithm, the element identifiers to select an element for recovery, and appending the element identifier associated with the selected element to a recovery list. When the predetermined rule is satisfied, sorting using the first sorting algorithm is stopped.

The method still further comprises using a second sorting algorithm different from the first sorting algorithm to sort element identifiers not already selected by the first sorting algorithm. In this regard, the sort using the second sorting algorithm may start or otherwise occur in parallel with the sort using the first algorithm, e.g., by starting before the predetermined rule is satisfied. Alternatively, the second sorting algorithm can start after the first sorting algorithm has stopped, e.g., the second sorting algorithm can start after the predetermined rule is satisfied.

The method also comprises appending the element identifiers sorted by the second sorting algorithm to the recovery list in an order determined by the second sorting algorithm. The method still further comprises recovering the elements associated with the element identifiers in the recovery list in the order in which the element identifiers are in the recovery list. Here, recovery occurs in parallel with a select one of: the sorting using the second algorithm, and both the sorting using the second sorting algorithm and the sorting using the first sorting algorithm.

### BRIEF DESCRIPTION OF THE SEVERAL VIEWS OF THE DRAWINGS

FIG. 1 is a block diagram of a system for performing backups, according to various aspects of the present disclosure;

FIG. 2 is a flow chart illustrating a method for creating a backup of a file system, according to various aspects of the present disclosure;

FIG. 3 is a tree diagram of an example of a file system, according to various aspects of the present disclosure;

FIG. 4 is a flow chart illustrating a method for recovering backed up elements to a file system, according to various aspects of the present disclosure; and

FIG. 5 is a block diagram of a computer system having a computer readable storage medium for implementing functions according to various aspects of the present disclosure.

### DETAILED DESCRIPTION

According to aspects of the present disclosure, a backup operation is performed using two different sorting algorithms. While or after a file system is being scanned, a first sorting algorithm is used to find at least one element (e.g., file, directory, etc.) that is required for the backup. By way of example, the first sorting algorithm can produce a single sorted element per pass (e.g., a bubble sort). After one such element is found, the located element is queued for backup to a backup system. In this regard, a backup process can begin to perform a backup on each such queued element, even while the sorting continues. After one or more elements have been queued for backup based upon the first sorting algorithm, a second sorting algorithm replaces the effort of the first sorting algorithm to sort the rest of the elements for backup. For example, the second sorting algorithm may not present any of the sorted elements until after the sorting is complete (e.g., a quicksort or a merge sort). While the second algorithm is sorting elements, which may be performed rather efficiently, the backup process can backup (or continue to backup) elements placed in the queue. Also, any results of the second algorithm are appended to the queue as they are completed. The backup operation typically runs until all of the elements placed in the queue have been backed up.

Similarly, a recovery operation is performed using two different sorting algorithms. While or after backup catalogs are being scanned and merged, a first sorting algorithm is used to find at least one element (e.g., file, directory, etc.) that is required for the recovery. In an analogous manner to the backup operation, the first sorting algorithm (e.g., a bubble sort) can produce a single sorted element per pass. After one such element is found, the located element is queued for recovery, e.g., to the file system. The forward order of sorted media indices help in efficient use of computing resources with recovery media such as sequential media or memory or disk systems, including but not limited to optical, magnetic or magneto optical systems. In this regard, a recovery process can begin to perform a recovery on each queued element, even while the sorting continues.

After one or more elements have been queued for recovery based upon the first sorting algorithm, a second sorting algorithm replaces the effort of the first sorting algorithm to sort the rest of the elements for recovery. For example, the second sorting algorithm may not present the sorted elements until after the sorting is complete (e.g., quicksort, merge sort). While the second algorithm is sorting elements, the recovery process can recover (or continue to recover) elements placed in the queue. The recovery operation typically runs until all of the elements placed in the queue have been recovered, e.g., back to the file system.

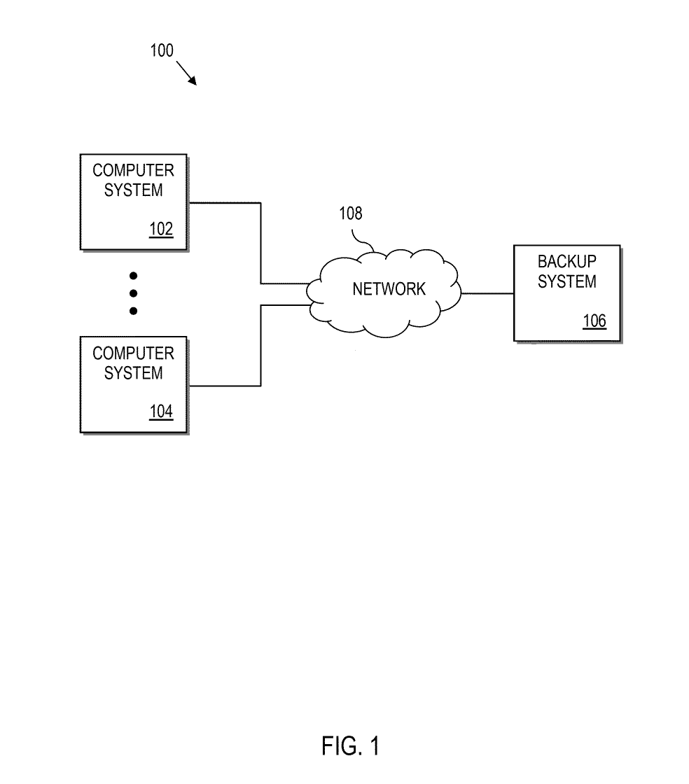

Referring to figures, and specifically to FIG. 1, an environment for creating a backup of a file system using two sorting algorithms and restoring backed up elements to the file system using two sorting algorithms is shown. The simplified environment 100 includes one or more computer systems connected to a backup system. For simplicity of discussion, FIG. 1 illustrates two computer systems 102, 104 with file systems. The computer systems 102, 104 are connected to a backup system 106 through a network 108. While shown as computer systems 102, 104, any system with a file system may be backed up. For example, the computer systems 102, 104 may include a server computer, an appliance, personal computer, a laptop, a cell phone, a smart phone, a tablet computer, pervasive computing device, etc., or combinations thereof. Further, while two computer systems 102, 104 are shown, any number of computer systems may be coupled to the backup system 106.

Moreover, the backup system 106 is illustrated as a single server; however, any backup system 106 may be used. For example, the backup system 106 may include a server, a tape drive, an external hard disk (or disks), optical storage, solid-state storage, cloud storage, etc., or combinations thereof. As such, the backup system 106 may include one or several components located in the same place or spread out over different locations.

Still further, the computer systems 102, 104 are illustrated as being coupled to the backup system 106 through the network 108, which may include a wide-area network (WAN), local-area network (LAN), the Internet, a peer-to-peer network, etc. However, the computer systems 102, 104 may be coupled to the backup system 106 in other ways including a direct bus connection (e.g., universal serial bus (USB), PCI-Express, etc.) or any other way two or more devices may communicate.

As such, the systems 100 illustrated in FIG. 1 and described herein may implement the methods described herein. The methods may be implemented in any of the components 102, 104, 106, 108, split among the components 102, 104, 106, 108, or both.

Exemplary Backup Operation:

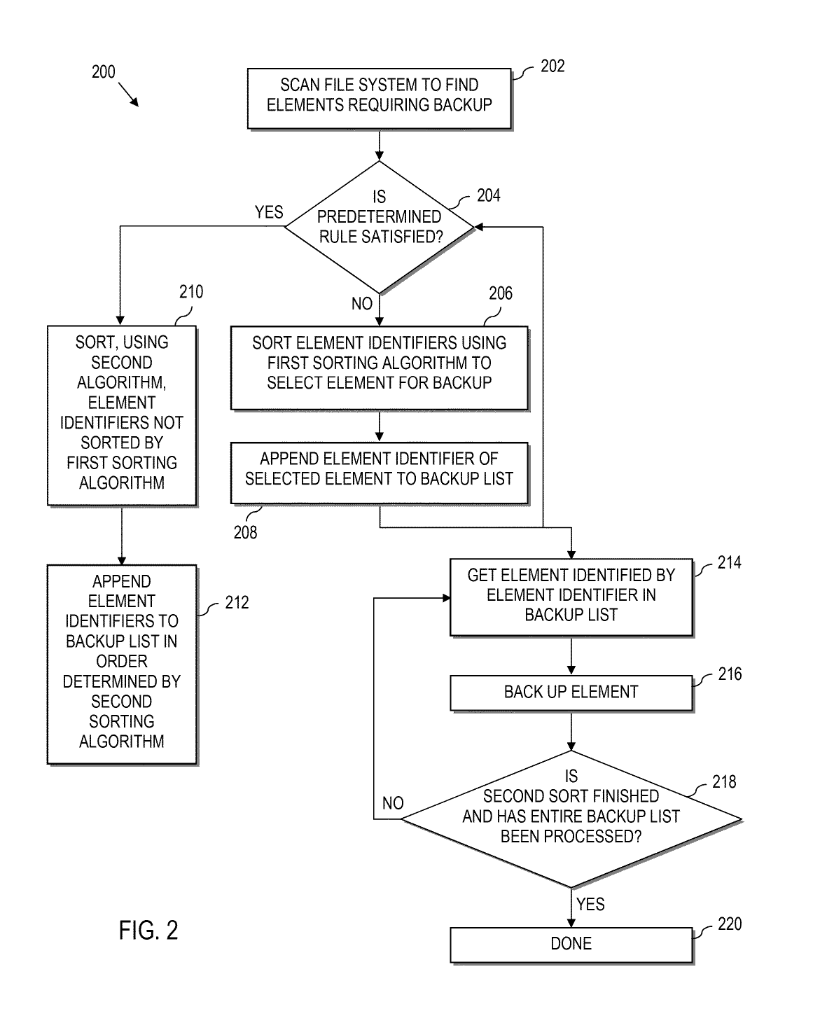

FIG. 2 illustrates a method 200 for creating a backup of a file system. The method 200 may be implemented by a processor coupled to memory, where the memory includes instructions that when read and executed by the processor, perform the recited method 200. The method 200 may also be embodied on computer-readable storage hardware.

At 202, the method 200 scans the file system to find elements (e.g., files, directories, e-mails, etc.) that require a backup. For example, for a full backup, the file system is scanned to find all of the elements of the file system. However, for a partial backup (e.g., incremental, differential, reverse delta, etc.), the file system is scanned to find elements that meet a criterion for backup (e.g., an element that has changed since the last time the element was backed up). Any type of scanning algorithm (e.g., depth-first scan, breadth-first scan, etc.) may be used to perform the scan, which can include a full scan of the file system or a partial scan of the file system (e.g., scanning one or more levels of a hierarchical file system).

The elements found via the scan include element identifiers (e.g., file name, file size, timestamp, other metadata, the file itself, a checksum, etc., or combinations thereof). In an illustrative implementation, the scan of the file system at 202 is carried out in a first thread.

At some point, a sort of the located element identifiers is started using a first sorting algorithm. The sort using the first sorting algorithm may start after the file system is scanned. In other implementations, the first sorting algorithm is started before the file system scan is complete. The particular application will dictate when to begin the first sorting algorithm. More particularly, at 204, the method determines if a predetermined rule is satisfied. The predetermined rule can be any applicable rule that determines when to stop taking results of the first sorting algorithm to perform backups. For example, the predetermined rule may be satisfied when the number of elements sorted by the first algorithm is greater than or equal to a predetermined threshold (i.e., sort a certain number of elements with the first sorting algorithm before moving on to sorting the rest with the second algorithm). For example, the predetermined threshold may be one element, five elements, or any positive number.

As an illustrative example, assume that the first sorting algorithm is a bubble sort. As soon as the first candidate for backup is produced by the first sorting algorithm in its first pass using the bubble sort, the backing up operation can occur in parallel with the sorting performed by the first algorithm. That is, the backup does not wait for the first sorting algorithm to terminate before beginning its backup operation. Rather, the backup operation can start backing up as element identifiers are placed in a backup list, as described below. In alternative implementations, the backup operation can wait until the first sorting algorithm is terminated.

At some point before the located element identifiers in the scanned file system are entirely sorted, the first sorting algorithm is terminated. A second sorting algorithm replaces the effort of the first sorting algorithm to finish sorting the located element identifiers. In this regard, the second sorting algorithm may begin upon termination of the first sorting algorithm. In alternative implementations, the second sorting algorithm can begin before the first sorting algorithm terminates. As such, the first sorting algorithm and the second sorting algorithm can operate in parallel.

Thus, as an example, if the number of elements required to satisfy the predetermined rule is greater than one, the backing up may occur in parallel with both the sorting performed using the second sorting algorithm and the sorting performed using the first sorting algorithm.

As mentioned above, the second sorting algorithm may occur in parallel with the first algorithm, after the first sorting algorithm, or both (i.e., starting while the first algorithm occurs and continuing after the first sorting algorithm completes). As such, the backing up can occur in parallel with the first sorting algorithm alone (e.g., when the first element of the first sorting algorithm is sorted), in parallel with the first sorting algorithm while the second algorithm is also sorting, or in parallel with just the second sorting algorithm (e.g., after the first sorting algorithm completes but before the second algorithm completes). The backing up will also continue after both algorithms have stopped.

Another example of a predetermined rule is a determination as to whether the entire system has been fully scanned (but not yet fully sorted). In this example, the backing up may occur in parallel with both the sorting performed using the second sorting algorithm and the sorting performed using the first sorting algorithm, as described above.

A further example of a predetermined rule includes comparing an estimated amount of time to complete a sort of all of the elements not sorted by the first sorting algorithm to an estimated amount of time to backup all of the elements already sorted but not yet backed up. Also, other predetermined rules may be used.

Returning to the method 200 of FIG. 2, if the predetermined rule is not satisfied, then the method proceeds to sort the element identifiers of the elements using the first sorting algorithm to select an element for backup at 206. Thus, the sorting at 206 finds at least one element. For example, the sort can be a (reverse) bubble sort that finds an element with the lowest alphanumeric element based upon a corresponding element identifier (e.g., filename) and then selects that element.

When the element is selected, the element identifier of the selected element is appended to a backup list at 208 (i.e., the element identifier of the selected element is published). The backup list acts as a “files to be backed up queue”. If no backup list exists, then the backup list is created and the element identifier of the selected element is appended to the backup list as the first element in the backup list.

The method 200 loops back to determine if the predetermined rule has been satisfied at 204. Also, the method 200 is capable of parallel processing of sorting and backing up. For instance, in an illustrative implementation, the method 200 creates a second thread such that backing up at 214-220 (described below) are performed in parallel with further iterations through 204-212, as described more fully below. If the second thread already exists from a previous pass through 208, then another thread is not necessarily created.

If the predetermined rule is satisfied at 204, then the method sorts the element identifiers not already sorted by the first algorithm using a second sorting algorithm at 210. However, as noted in greater detail above, the second sort may also occur in parallel with the sorting using the first sorting algorithm, e.g., using another thread. Thus, although FIG. 2 illustrates sorting using the second algorithm 210 after the predetermined rule is satisfied at 204, in practice the start of the sort using the second sorting algorithm can occur either before or after the predetermined rule is satisfied. However, regardless of when started, the second sorting algorithm continues to sort the previously unsorted element identifiers located for backup after the first sorting algorithm is terminated. The element identifiers are appended to the backup list in an order defined by the second sorting algorithm at 212. At this point the backup list is completed, and the first thread may stop (where utilized).

In general, whereas the first sorting algorithm may be an inefficient algorithm overall (if required to run to completion), the second sorting algorithm should be an efficient sorting algorithm when run to completion. For example, the first algorithm may be a bubble sort (which requires time on the order of N²) to sort to completion. However, the first sorting algorithm, e.g., a bubble sort, is efficient at producing partial sort results of the overall sort in order of N. On the other hand, the second algorithm may be a much more efficient quicksort algorithm (which requires time on the order of N*log(N)) to perform the remainder of the sort.

As mentioned above, around 208, a second thread may be created to perform backup at 214-220 in parallel with sorting at 204-212. At 214, the element associated with the first/next element identifier in the backup list is identified, and at 216, that element is backed up. When the element is backed up, some indication may be made to indicate a successful backup (e.g., remove the element identifier from the list, mark the element identifier as being backed up, etc.). The time required to back up the element is probably longer than the time to sort the next element for the backup list (see 206 and 204 above). Thus, while the element is being backed up, at least one more element identifier may be added to the backup list.

At 218, if the process of sorting the elements using the second sorting algorithm and appending those sorted elements to the backup list (i.e., 210, 212) is not complete or if the entire backup list has not been processed, then the method loops back to 214 to get the element associated with the next element identifier in the backup list. This loop from 218 back to 214 continues until the second sorting algorithm has completed and all sorted elements have been appended to the backup list, and until the entire backup list has been processed (i.e., all of the element elements associated with the element identifiers in the backup list have been backed up), at which point the method completes at 220. Thus, elements associated with the element identifiers in the backup list are backed up in the order in which the element identifiers are in the backup list. Moreover, the backup occurs in parallel with the first sorting algorithm, the second sorting algorithm or both.

While it is counter intuitive to use an inefficient algorithm (inefficient by orders of magnitude) to perform a sort operation, the time to back up an individual element is I/O (input/output) intensive and is usually considerably longer than the time to sort for an individual element using the first sorting algorithm, as set out herein. Thus, the backup list can be created and completed while the first several elements are being backed up, resulting in backup windows shorter than traditional backup/sorting processes that use the efficient sorting algorithm only. The time for this two-algorithm sort and backup effectively reduces the backup window of a traditional backup by the time used by the traditional backup to sort the elements (e.g., N*log(N)).

Further, by using the efficient algorithm to finish the sorting, the overall time required to sort the elements is orders of magnitude faster than sorting with the inefficient algorithm. Therefore, the two-algorithm sort uses less processing resources on the computer system than using the inefficient sorting algorithm for the entire sort.

The blocks of the flow chart may be performed in a different order or in parallel. For example, determining if the predetermined rule is satisfied (at 204) may occur after the first element identifier has been appended to the backup list (at 208). Further, when using a depth-first scan, the initial scanning (at 202) or additional scanning may be within the loop of 204-208. Moreover, the scan can be performed in parallel with the first sorting algorithm in some cases. Other changes in the order of the flow chart can exist that are not specifically listed here.

Producer-Consumer Queue Mechanism for Backup and Restore:

According to various aspects of the present disclosure, the methods described more fully herein can be used to leverage producer-consumer queue mechanisms to perform backup operations.

Working Example:

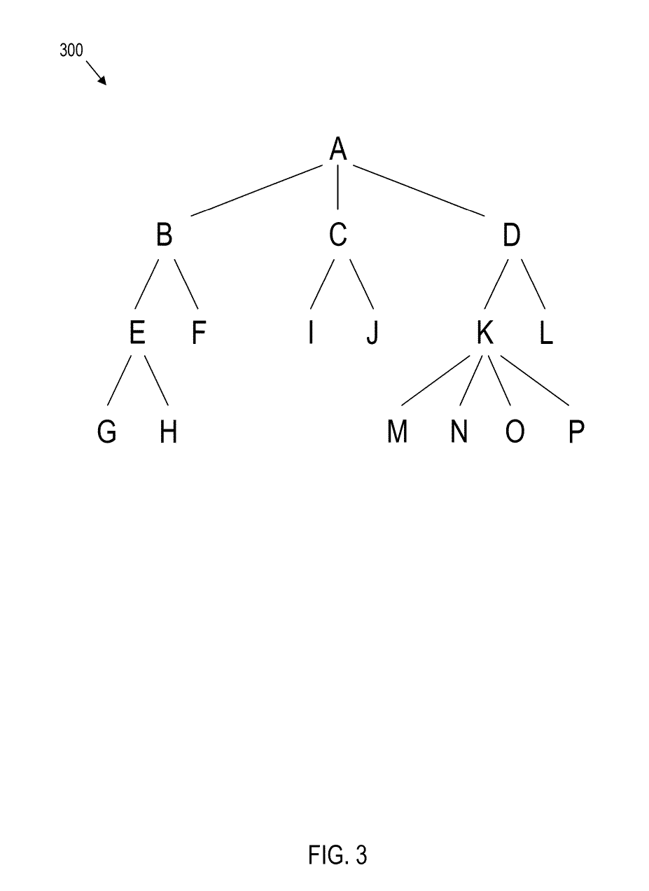

With continued reference to FIG. 2 and reference to FIG. 3, a hierarchical tree of an example file system 300 is shown. The hierarchical tree will be used in a non-limiting example illustrating the method 200 of FIG. 2. In the example, a full backup of the entire file system 300 will be performed. Moreover, in this example, the element identifiers are filenames of the elements. The scanning method is a depth-first scan, the first sorting algorithm is a bubble sort that determines the lowest alphanumeric filename of the elements, and the second sorting algorithm is a quicksort that orders the filenames of the elements from lowest to highest alphanumerically. Further, the predetermined rule is a rule that determines whether the number of elements sorted by the bubble sort is five.

A first thread scans the top level at 202 and indicates that the only element is A. At 204, the predetermined rule is found to be unsatisfied, because the number of elements sorted by the bubble sort is less than five. At 206, the elements are sorted using the bubble sort, and element A is selected. At 208, it is determined that no backup list exists, thus a backup list is created, and the element identifier for A is appended to the backup list. A second thread is initiated to perform the backups.

At 214, element A is selected for backup, because A is the only element identifier on the backup list. Then, at 216, element A is backed up. While element A is being selected and backed up (214 and 216 respectively), the predetermined rule is checked and found to be unsatisfied, so a scan is performed of the first level under A, which reveals elements B, C, and D. B, C, and D are sorted and element B is selected because it is the lowest alphanumerically. That is, sorting the element identifiers to select an element for backup (using the first sorting algorithm) includes determining a lowest alphanumeric filename and selecting the element with the lowest alphanumeric filename. The filename (element identifier in this example) A\B is appended to the backup list at 208, and the method 200 loops back to 204.

Only two elements have been sorted, so the predetermined rule remains unsatisfied. Because of the depth-first scan, the level under B is scanned and sorted before sorting the rest of the first level under A. The scan of the level under B reveals E and F, which are sorted with the bubble sort at 206. Element A\B\E is appended to the backup list at 208, and the first thread loops back to 204.

Only three elements have been sorted, so the predetermined rule remains unsatisfied. Because of the depth-first scan, the level under E is scanned and sorted before sorting the rest of the first level under A and the first level under B. The scan of the level under E reveals G and H, which are sorted with the bubble sort at 206. Element A\B\E\G is appended to the backup list at 208, and the first thread loops back to 204.

During the previous loops, element A was backed up at 216 and element identifier A is removed from the backup list. However, the second sort had not finished (the second sort has not even started at this point), so the second thread loops back to 214 to find the next element identifier in the backup list: A\B. At 216, the second thread backs up element A\B.

Going back to the progress of the first thread, only four elements have been sorted, so the predetermined rule remains unsatisfied. There are no levels under G, so the rest of the level under E is sorted again to select element H. Element A\B\E\H is appended to the backup list at 208, and the first thread loops back to 204.

At this point, five elements have been sorted by the first sorting algorithm, so the predetermined rule is satisfied. Accordingly, the first thread proceeds to 210 and scans the rest of the tree 300. The filenames from the scan are quicksorted into the following order:
A\B\F
A\C
A\C\I
A\C\J
A\D
A\D\K
A\D\K\M
A\D\K\N
A\D\K\O
A\D\K\P
A\D\L

The element identifiers of those elements are appended to the backup list in that order. The first thread then stops.

During this time, the second thread continues to select elements based on the order the element identifiers were put into the backup list and continues to back up those selected elements. Once the second sort is completed (and appended to the backup list) and all of the elements associated with the element identifiers in the backup list have been backed up, the second thread stops.

Therefore, with the two-algorithm sort and backup method 200, a depth-first scan can be performed in parallel with the backup once the first element is identified and sorted. Moreover, the first sorting algorithm may start after a first hierarchical level of the file system is scanned. In a more particular example, the first sorting algorithm may start after a first hierarchical level of the file system is scanned and before a second hierarchical level of the file system is scanned.

Three Thread Example:

In yet another illustrative example, an operation (backup or restore) may comprise three threads.

In a first thread, the process generates a depth first scan of a folder level, and a first list of elements is generated from the scanned folder level. The first thread also performs a sort, e.g., bubble sort, of the elements in the first list. Still further, the first thread publishes to the second and third threads, a first published file that contains at least the smallest element (e.g., in descending order) obtained from the sort. For instance, the first thread may publish a first file that contains at least the smallest element that has been sorted. The published element is removed from first list.

In an illustrative implementation, a second thread performs several functions. The second thread extracts an element from the first published file, e.g., an element that represents a node, and performs a read to produce a child element list. The second thread can publish the node. Moreover, the second thread appends the child element list to the end of the first list in the first thread.

The third thread performs the backup based upon the element(s) published in the second published file. The above process iterates until the entire file system has been scanned and queued for backup by the third thread.

This allows for an efficient backup. For instance, as soon as the first smallest element is surfaced, the backup can be kicked off. Also, a depth first search of that smallest element can be kicked off. This provides essentially, a continuous stream of elements, e.g., file names, to be backed up and traversed further.

Exemplary Recovery Operation:

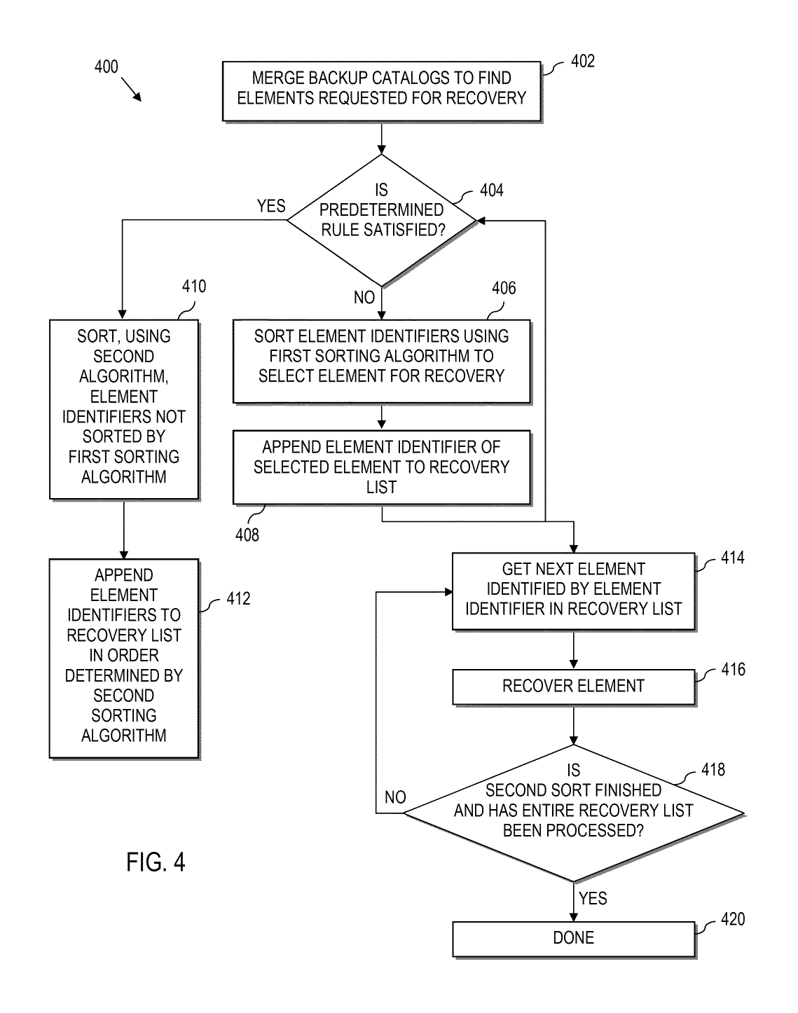

Similarly, the two-algorithm sort may be used in a recovery operation, as shown in the method 400 of FIG. 4. The method 400 may be implemented by a processor coupled to memory, where the memory includes instructions that when read and executed by the processor, perform the recited method 400. The method 400 may also be embodied on computer-readable storage hardware.

At 402, the method 400 scans a backup system to find elements (e.g., files, directories, etc.) requested for a recovery of a file system. For example, if a full backup and one or more incremental backups were performed then the recovery elements may be located in several places within the backup system. In some instances, a specific element may be in the full backup and each of the incremental backups. As such, the elements from the backup system may be scanned and merged to create a master list of all elements available for recovery. For instance, a flattened list may be created by merging backup catalogs and adding elements requested for recovery to the flattened list that were located in the merged backup catalogs.

In a manner analogous to that set out with reference to the method 200 of FIG. 2, any type of scanning algorithm may be used to perform the scan, which can include for instance, a full scan of the file system or a partial scan of the file system. Also, the elements found via the scan include element identifiers (e.g., file name, file size, timestamp, other metadata, the file itself, a checksum, etc., or combinations thereof). In an illustrative implementation, the scan of the backup system at 402 can be carried out in a first thread.

At 404, the method determines if the predetermined rule is satisfied. The predetermined rule can be any applicable rule that determines when to switch from a first sorting algorithm to a second sorting algorithm, or when to otherwise terminate the first sorting algorithm. For example, the predetermined rule may be whether the number of elements sorted by the first algorithm is greater than or equal to a predetermined threshold (i.e., sort a certain number of elements with the first sorting algorithm before moving on to sorting the rest with the second algorithm). For example, the predetermined threshold may be one element, five elements, or any positive number. Another example of a predetermined rule is whether the entire backup system has been fully scanned and merged into a list, e.g., a flattened file. A further example of a predetermined rule includes comparing an estimated amount of time to complete a sort of all of the elements not sorted by the first sorting algorithm to an estimated amount of time to recover all of the elements already sorted but not yet recovered. Also, other predetermined rules may be used.

The predetermined rule may also be analogous to that set out with regard to FIG. 2, except that the backup process of FIG. 2 is replaced with the recovery process. For instance, in the method 400, a predetermined rule may be satisfied when the number of elements selected with the first algorithm is equal to one. In this example, the recovery occurs in parallel with the sorting performed with the second algorithm. As another example, the predetermined rule may be satisfied when the number of elements selected with the first algorithm is equal to a predetermined threshold greater than one. In this example, the recovery occurs in parallel with both the sorting performed using the second sorting algorithm and the sorting performed using the first sorting algorithm. As yet another example, the predetermined rule may be a determination as to whether the backup catalogs have been merged entirely. In this example, the recovery occurs in parallel with both the sorting performed using the second sorting algorithm and the sorting performed using the first sorting algorithm.

If the predetermined rule is not satisfied, then the method proceeds to sort the element identifiers of the elements using a first sorting algorithm to select an element for backup at 406. Thus, the sorting at 406 finds at least one element. For example, the sort can be a bubble sort that finds an element with the oldest timestamp and then selects that element.

When the element is selected, the element identifier of the selected element is appended to a recovery list at 408 (i.e., the element identifier of the selected element is published). Analogous to that set out with regard to FIG. 2, if no recovery list exists, then the recovery list is created and the element identifier of the selected element is appended to the recovery list as the first element in the recovery list.

The method 400 loops back to determine if the predetermined rule has been satisfied at 404. Also, the method 400 is capable of parallel processing. For instance, in an illustrative implementation, the method 400 creates a second thread such that recovery at 414-420 (described below) are performed in parallel with further iterations through sorting at 402-412, as described more fully below. If the second thread already exists from a previous pass through 408, then another thread is not necessarily created.

If the predetermined rule is satisfied at 404, then the method sorts the element identifiers not already sorted by the first algorithm, using a second sorting algorithm at 410. In illustrative examples, the first sorting algorithm is terminated upon the predetermined rule being satisfied. However, the second sorting algorithm may start upon termination of the first sorting algorithm, or the second sorting algorithm may start before the first sorting algorithm terminates, thus facilitating parallel processing of the first and second sorting algorithms, as described more fully herein. The element identifiers are appended to the recovery list in an order defined by the second sorting algorithm at 212. At this point the recovery list is completed, and the first thread may stop (where utilized).

In a manner analogous to the method 200 of FIG. 2, the first algorithm may be a bubble sort (which requires time on the order of N²), whereas the second algorithm may be a much more efficient quicksort algorithm (which requires time on the order of N*log(N)).

As mentioned above, around 408, a second thread may be created to perform 414-420 in parallel with 404-412. At 414, the element associated with the first/next element identifier in the recovery list is identified, and at 416, that element is recovered. Once the element associated with the element identifier is recovered, some indication may be made to indicate a successful recovery (e.g., remove the element identifier from the recovery list, mark the element identifier as being recovered, etc.). The time required to recover the element is probably longer than the time to sort the next element for the recovery list (see 406 and 404 above). Thus, while the element is being recovered, at least one more element identifier may be added to the recovery list.

At 418, if the process of sorting the elements using the second sorting algorithm and appending those sorted elements to the recovery list (i.e., 410, 412) is not complete or if the entire recovery list has not been processed, then the method loops back to 414 to get the element associated with the next element identifier in the recovery list. This loop from 418 back to 414 continues until the second sorting algorithm has completed and all sorted elements have been appended to the backup list, and until the entire recovery list has been processed (i.e., all of the element elements associated with the element identifiers in the recovery list have been recovered), at which point the method completes at 220. In other words, the recovery occurs in parallel with the first sorting algorithm, the second sorting algorithm or both.

Also, in a manner analogous to that described with reference to FIG. 2, the element identifiers may be filenames of the elements. In this exemplary implementation, the first sorting algorithm (e.g., bubble sort), may sort the element identifiers alphanumerically. As such, an element may be selected for recovery by determining a lowest alphanumeric filename and selecting the element with the lowest alphanumeric filename. As yet another example, the element identifiers may be timestamps of the elements. In this regard, the first sorting algorithm may sort the element identifiers chronologically. As such, an element may be selected for recovery by determining an oldest timestamp and selecting the element with the oldest timestamp.

As with the backup process (200, FIG. 2), while it is counter intuitive to use an inefficient algorithm (inefficient by orders of magnitude) to sort, the time to recover an individual element is I/O (input/output) intensive and is usually considerably longer than the time to sort for an individual element using the first sorting algorithm. Thus, the recovery list can be completed while the first several elements are being recovered, resulting in recovery windows shorter than traditional recovery/sorting processes that use the efficient sorting algorithm only. The time for this two-algorithm sort and recovery effectively reduces the recovery window of a traditional recovery by the time used by the traditional recovery to sort the elements (e.g., N*log(N)).

Further, by using the efficient algorithm to finish the sorting, the overall time required to sort the elements is orders of magnitude faster than sorting with the inefficient algorithm. Therefore, the two-algorithm sort uses less processing resources on the backup system than using the inefficient sorting algorithm for the entire sort.

As with the backup process (200, FIG. 2), the blocks of FIG. 4 may be performed in a different order or in parallel.

Producer-Consumer Recovery:

The recovery operation can also be implemented in a Producer-Consumer model. In this exemplary implementation, the recovery operation merges all catalogs from a full backup to a point of recovery, and creates a full file system image. The recovery operation also performs a forward sort of files with the oldest files first (media, offset), and publishes the sorted file as the first candidate surfaces. This enables a recovery thread to perform a recovery while the sort is in progress. As such, the recovery operation can recover data in a forward sort order, fetching media in the right sequence. This ensures parallel recovery operations and ensures that there is no backward seeks.

By way of example, a first thread merges a file list to create a published file list. A second thread performs a bubble sort, publishes the lowest element in each scan (e.g., by media offset). The published lowest element is processed by a third thread to recover the published element. The above-process iterates until all necessary files have been recovered.

Miscellaneous Considerations:

According to aspects of the present disclosure herein, methods of performing a backup and a restore are provided, which perform parallel processing, thus eliminating at least a portion of the idle time that is conventionally wasted waiting for the system to perform a depth first scan of the files to be backed up. For instance, a typical depth first scan of 10 million files can take as much as three hours or more on certain systems. During this time, the actual backup in a conventional process is not being carried out. Rather, this time is required to build the “catalog” of files that will subsequently be backed up. By way of example, a typical quicksort algorithm may be efficient at sorting. Nonetheless, a drawback of the quicksort algorithm is that the list of sorted elements is not available until the entire quicksort process has run to completion.

However, according to aspects of the present disclosure herein, a first sort is used that is capable of quickly obtaining enough elements to allow the backup process to start and run. Once the backup is running in parallel, a second, more efficient (overall) sorting algorithm can be used to sort the remainder of the elements. By way of example, a bubble sort produces the smallest x elements in order of complexity (N) facilitating the start of parallel processing, even though the overall complexity of the bubble sort is (N²). Once the bubble sort returns one or more elements, the method can switch over to a more efficient sort, e.g., a quick sort, which has a computational complexity of Nlog(N).

Computer Overview:

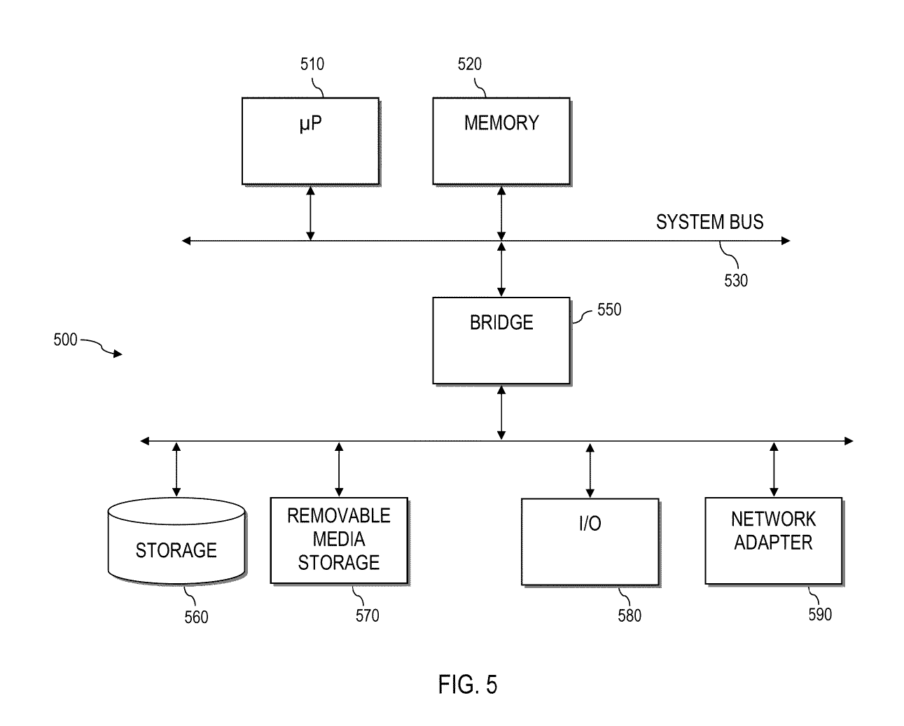

Referring to FIG. 5, a schematic block diagram illustrates an exemplary computer system 500 for implementing the various methods described herein, e.g., by interacting with a user. The exemplary computer system 500 includes one or more microprocessors (μP) 510 and corresponding memory 520 (e.g., random access memory and/or read only memory) that are connected to a system bus 530. Information can be passed between the system bus 530 and bus 540 by a suitable bridge 550. The bus 540 is used to interface peripherals with the one or more microprocessors (μg) 510, such as storage 560 (e.g., hard disk drives); removable media storage devices 570 (e.g., flash drives, DVD-ROM drives, CD-ROM drives, floppy drives, etc.); I/O devices 580 (e.g., mouse, keyboard, monitor, printer, scanner, etc.); and a network adapter 590. The above list of peripherals is presented by way of illustration, and is not intended to be limiting. Other peripheral devices may be suitably integrated into the computer system 500.

The microprocessor(s) 510 control operation of the exemplary computer system 500. Moreover, one or more of the microprocessor(s) 510 execute computer readable code that instructs the microprocessor(s) 510 to implement the methods herein. The computer readable code may be stored for instance, in the memory 520, storage 560, removable media storage device 570 or other suitable tangible storage medium accessible by the microprocessor(s) 510. The memory 520 can also function as a working memory to store information (e.g., data, an operating system, etc.).

Thus, the exemplary computer system 500 or components thereof can implement the methods (e.g., the method 200 of FIG. 2 and the method 400 of FIG. 4). The exemplary computer system 500 can also provide computer-readable storage device(s) that store code that can be executed to implement the methods (e.g., the method 200 of FIG. 2 and the method 400 of FIG. 4) as set out in greater detail herein. Other computer configurations may also implement the methods and computer-readable storage devices as set out in greater detail herein.

Computer program code for carrying out operations for various aspects of the present disclosure set out herein, may be written in any combination of one or more programming languages. The program code may execute entirely on the computer system 500. Alternatively, the program code may execute partly on the computer system 500 and partly on a remote computer Here, the remote computer may be connected to the computer system 500 through any type of network connection, e.g., using the network adapter 590 of the computer system 500. Still further, the program code may be implemented on a remote computer.

The flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read -only memory (EPROM or Flash memory), an appropriate optical fiber with a repeater, a portable compact disc read-only memory (CORaM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “c” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, material s, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
identifying elements for backup, wherein the elements include element identifiers;
sorting, using a first sorting algorithm, element identifiers of elements identified for backup to select a sorted element and append the element identifier associated with the selected element to a backup list;
sorting, using a second sorting algorithm different from the first sorting algorithm, element identifiers not already selected by the first sorting algorithm for backup;
appending the element identifiers sorted by the second sorting algorithm to the backup list in an order determined by the second sorting algorithm; and
backing up the elements associated with the element identifiers in the backup list in the order in which the element identifiers are in the backup list, wherein the backing up occurs in parallel with a select one of: the sorting using the second algorithm, and both the sorting using the second sorting algorithm and the sorting using the first sorting algorithm.

2. The method of claim 1, wherein:
sorting, using a first sorting algorithm comprises:
sorting, using the first sorting algorithm, until a predetermined rule is satisfied, where the predetermined rule is satisfied when the number of elements selected with the first algorithm is equal to one; and
the backing up occurs in parallel with the sorting performed with the second algorithm.

3. The method of claim 1, wherein:
sorting, using a first sorting algorithm comprises:
sorting, using the first sorting algorithm, until a predetermined rule is satisfied, where the predetermined rule is satisfied when the number of elements selected with the first algorithm is equal to a predetermined threshold greater than one; and
the backing up occurs in parallel with both the sorting performed using the second sorting algorithm and the sorting performed using the first sorting algorithm.

4. The method of claim 1, wherein:
sorting, using a first sorting algorithm comprises:
sorting, using the first sorting algorithm, until a predetermined rule is satisfied, where the predetermined rule is a determination as to whether an entire file system has been scanned to identify elements for backup; and
the backing up occurs in parallel with both the sorting performed using the second sorting algorithm and the sorting performed using the first sorting algorithm.

5. The method of claim 1, wherein:
sorting, using a first sorting algorithm, comprises sorting using a bubble-sort algorithm; and
sorting, using a second sorting algorithm different from the first sorting algorithm, comprises sorting using a quicksort algorithm.

6. The method of claim 1, wherein:
identifying elements for backup, wherein the elements include element identifiers comprises identifying elements for backup having element identifiers that are filenames of the elements; and
sorting, using a first sorting algorithm, further includes determining a lowest alphanumeric filename and selecting the element with the lowest alphanumeric filename.

7. The method of claim 1, wherein:
identifying elements for backup comprises scanning a file system to find elements for a backup using a depth-first scan; and
sorting, using a first sorting algorithm, comprises starting the first sorting algorithm after a first hierarchical level of the file system is scanned.

8. The method of claim 7, wherein sorting, using the first sorting algorithm, comprises starting the first sorting algorithm after a first hierarchical level of the file system is scanned and before a second hierarchical level of the file system is scanned.

9. The method of claim 1, wherein:
sorting, using a first sorting algorithm comprises:
sorting, using the first sorting algorithm, until a predetermined rule is satisfied; and
sorting, using a second sorting algorithm different from the first sorting algorithm comprises:
starting the second sorting algorithm before the predetermined rule is satisfied.

10. The method of claim 1 further including removing an element identifier from the backup list once the element associated with the element identifier is backed up.

11. A method comprising:
identifying elements for recovery, wherein the elements include element identifiers;
sorting, using a first sorting algorithm, element identifiers of elements identified for recovery to select a sorted element and append the element identifier associated with the selected element to a recovery list;
sorting, using a second sorting algorithm different from the first sorting algorithm, element identifiers not already selected by the first sorting algorithm;
appending the element identifiers sorted by the second sorting algorithm to the recovery list in an order determined by the second sorting algorithm; and
recovering the elements associated with the element identifiers in the recovery list in the order in which the element identifiers are in the recovery list, wherein the recovery occurs in parallel with a select one of: the sorting using the second algorithm, and both the sorting using the second sorting algorithm and the sorting using the first sorting algorithm.

12. The method of claim 11, wherein:
sorting, using a first sorting algorithm comprises:
sorting, using the first sorting algorithm, until a predetermined rule is satisfied, where the predetermined rule is satisfied when the number of elements selected with the first algorithm is equal to one; and
the recovery occurs in parallel with the sorting performed with the second algorithm.

13. The method of claim 11, wherein:
sorting, using a first sorting algorithm comprises:
sorting, using the first sorting algorithm, until a predetermined rule is satisfied, where the predetermined rule is satisfied when the number of elements selected with the first algorithm is equal to a predetermined threshold greater than one; and
the recovery occurs in parallel with both the sorting performed using the second sorting algorithm and the sorting performed using the first sorting algorithm.

14. The method of claim 11, wherein:
identifying elements for recovery comprises:
merging backup catalogs to find elements for recovery;
sorting, using a first sorting algorithm comprises:
sorting, using the first sorting algorithm, until a predetermined rule is satisfied, where the predetermined rule is a determination as to whether the backup catalogs have been merged entirely; and
the recovery occurs in parallel with both the sorting performed using the second sorting algorithm and the sorting performed using the first sorting algorithm.

15. The method of claim 11, wherein:
sorting, using a first sorting algorithm, comprises sorting using a bubble-sort algorithm; and
sorting, using a second sorting algorithm different from the first sorting algorithm, comprises sorting using a quicksort algorithm.

16. The method of claim 11, wherein:
identifying elements for recovery comprises:
identifying elements for recovery having element identifiers that are filenames of the elements; and
sorting, using a first sorting algorithm, further includes determining a lowest alphanumeric filename and selecting the element with the lowest alphanumeric filename.

17. The method of claim 11, wherein:
identifying elements for recovery comprises:
identifying elements for recovery having element identifiers that are timestamps of the elements; and
sorting, using a first sorting algorithm, the element identifiers to select an element for recovery further includes determining an oldest timestamp and selecting the element with the oldest timestamp.

18. The method of claim 11, wherein:
identifying elements for recovery comprises:
merging backup catalogs to find elements for recovery by creating a flattened list of all elements requested for recovery.

19. The method of claim 11, wherein:
sorting, using a first sorting algorithm comprises:
sorting, using the first sorting algorithm, until a predetermined rule is satisfied; and
sorting, using a second sorting algorithm different from the first sorting algorithm comprises:
starting the second sorting algorithm before the predetermined rule is satisfied.

20. The method of claim 11 further including:
removing an element identifier from the recovery list once the element associated with the element identifier is recovered.
